(19) United States
(12) Patent Application Publication
(10) Pub. No.: US 2015/0368443 A1
(43) Pub. Date: Dec. 24, 2015

(54) Stability of Zinc Pyrithione Dispersions

(71) Applicant: The Procter & Gamble Company, Cincinnati, OH (US)

(72) Inventors: Henry Rafael RINCON, West Chester, OH (US); James Anthony STAUDIGEL, Loveland, OH (US)

(21) Appl. No.: 14/310,568

(22) Filed: Jun. 20, 2014

(51) Int. Cl. C08L 5/00; C08K 5/42; C08K 5/3432

(52) U.S. Cl. CPC C08L 5/00; C08K 5/3432; C08K 5/42

(57) ABSTRACT

A composition directed to comprising from about 25% to about 60% a pyrithione or polyvalent metal salt of a pyrithione; from about 0.01 to about 1% of a cationic polymer; from about 0.01% to about 2.0% of an anionic surfactant wherein the cationic polymer has a molecular weight from about 100,000 to about 2,000,000.

### FIELD OF THE INVENTION

The present invention relates to stabilizing a zinc pyrithione dispersion with a cationic polymer in the presence of an anionic surfactant.

### BACKGROUND OF THE INVENTION

High concentration aqueous zinc pyrithione (ZPT) dispersions are used as raw materials in the manufacturing of personal care compositions. Typical ZPT weight content of such concentrated dispersions range between about 25% and about 50% whereas personal care compositions typically contain less than or equal to about 2% ZPT.

Concentrated ZPT dispersions may be prepared in central locations and shipped in various manufacturing locations. High concentrations of stable ZPT are preferred both for economic reasons, such as higher dispersion manufacturing productivity and lower transportation costs, as well as final product formulation flexibility. As with many dispersions, settling of the particles over time during transportation and storage is commonly encountered, requiring remixing or re-dispersing of the particles shortly before use in the final product manufacturing process. The requirement of this remixing step, necessitates the use of smaller transportation packages, which may be mixed via an impeller more readily and economically. In some cases it also necessitates the frequent opening of the packages, which in turn could result in possible contamination via physical or microbial contamination and depletion of the contained preservative. Thus, improvements in dispersion and settling stability of the concentrated ZPT dispersion achieve multiple benefits both in cost and quality.

### SUMMARY OF THE INVENTION

In an embodiment of the present invention, a composition comprises from about 25% to about 60% a pyrithione or polyvalent metal salt of a pyrithione; from about 0.01 to about 1% of a cationic polymer; from about 0.01% to about 2.0% of an anionic surfactant wherein the cationic polymer has a molecular weight range from about 100,000 to about 2,000,000.

### DETAILED DESCRIPTION OF THE INVENTION

In all embodiments of the present invention, all percentages are by weight of the total composition, unless specifically stated otherwise. All ratios are weight ratios, unless specifically stated otherwise. All ranges are inclusive and combinable. The number of significant digits conveys neither a limitation on the indicated amounts nor on the accuracy of the measurements. All numerical amounts are understood to be modified by the word “about” unless otherwise specifically indicated. Unless otherwise indicated, all measurements are understood to be made at 25° C. and at ambient conditions, where “ambient conditions” means conditions under about one atmosphere of pressure and at about 50% relative humidity. All such weights as they pertain to listed ingredients are based on the active level and do not include carriers or by-products that may be included in commercially available materials, unless otherwise specified.

The term “comprising,” as used herein, means that other steps and other ingredients which do not affect the end result can be added. This term encompasses the terms “consisting of” and “consisting essentially of.” The compositions and methods/processes of the present invention can comprise, consist of, and consist essentially of the elements and limitations of the invention described herein, as well as any of the additional or optional ingredients, components, steps, or limitations described herein.

The terms “include,” “includes,” and “including,” as used herein, are meant to be non-limiting and are understood to mean “comprise,” “comprises,” and “comprising,” respectively.

The test methods disclosed in the Test Methods Section of the present application should be used to determine the respective values of the parameters of Applicants' inventions.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. The term “weight percent” may be denoted as “wt. %” herein.

It should be understood that every maximum numerical limitation given throughout this specification includes every lower numerical limitation, as if such lower numerical limitations are expressly written herein. Every minimum numerical limitation given throughout this specification will include every higher numerical limitation, as if such higher numerical limitations are expressly written herein. Every numerical range given throughout this specification will include every narrower numerical range that falls within such broader numerical range, as if such narrower numerical ranges are all expressly written herein.

The present invention relates to the stabilization of ZPT dispersions in the presence of Cationic Modified Guar Gum (Guar Hydroxypropyltrimonium Chloride) along with anionic surfactants of the family of sodium polynaphthalenesulfonate, a non-limiting example is Darvan from R.T. Vanderbilt Company, Inc. The stabilization of ZPT particles in the carrier is achieved by preventing aggregation/agglomeration of the particles and via prevention of settling. The mechanism of aggregation/agglomeration stabilization is via particle steric and/or electrostatic effects and the settling stability is achieved by increasing the low shear viscosity of the carrier. More specifically, the Cationic Modified Guar Gums (Guar Hydroxypropyltrimonium Chloride) thickens the continuous media delaying the rate of settling down of the ZPT particles, and the anionic surfactant modifies the charges in the surface of the ZPT particles, creating electrostatic repulsion between those particles that favor the ease of re-dispersion. Both the cationic guar gum and the anionic surfactant can also weakly bind on ZPT particles and provide steric stabilization because of their polymeric nature.

A. Pyridinethione Particulates/Pyrithione or Polyvalent Metal Salts of Pyrithione

Pyridinethione particulates are suitable particulates for use in composition of the present invention. In an embodiment, the pyridinethione is a 1-hydroxy-2-pyridinethione salt and is in particulate form. In an embodiment, the pyridinethione salts are those formed from heavy metals such as zinc, tin, cadmium, magnesium, aluminium, zirconium, barium, bismuth, strontium, copper and mixtures thereof. In an embodiment, the heavy metal may be zinc, a non-limiting example being the zinc salt of 1-hydroxy-2-pyridinethione (known as “zinc pyrithione” or “ZPT”), commonly 1-hydroxy-2-pyridinethione salts in platelet particle form. In an embodiment, the present invention may comprise pyrithione or a polyvalent metal salt of pyrithione. Any form of polyvalent metal pyrithione salts may be used, including platelet and needle structures.

In an embodiment, the 1-hydroxy-2-pyridinethione salts in platelet particle form have an average particle size of up to about 20 microns, or up to about 5 microns, or up to about 2.5 microns. Salts formed from other cations, such as sodium, may also be suitable. Pyridinethione anti-dandruff actives are described, for example, in U.S. Pat. No. 2,809,971; U.S. Pat. No. 3,236,733; U.S. Pat. No. 3,753,196; U.S. Pat. No. 3,761,418; U.S. Pat. No. 4,345,080; U.S. Pat. No. 4,323,683; U.S. Pat. No. 4,379,753; and U.S. Pat. No. 4,470,982.

In an embodiment of the present invention, the pyrithione or polyvalent metal salt of pyrithione may be present from about 25% to about 60%, in a further embodiment from about 30% to about 50%.

B. Cationic Polymer

The dispersion composition comprises a cationic polymer. The polymer can include at least one of (a) a cationic guar polymer, (b) a cationic non-guar galactomannan polymer, (c) a cationic starch polymer, (d) a cationic copolymer of acrylamide monomers and cationic monomers, (e) a synthetic cationic polymer, (f) a cationic cellulose polymer or (g) a mixture of such polymers. The molecular weight of the cationic polymer can be from about 100,000 to about 10,000,000 and its charge density can be between about 0.1 meq/g to about 7 meq/g.

(a) Cationic Guar Polymer

According to an embodiment of the present invention, the dispersion composition comprises a cationic guar polymer, which is a cationically substituted galactomannan (guar) gum derivatives. Guar gum for use in preparing these guar gum derivatives is typically obtained as a naturally occurring material from the seeds of the guar plant. The guar molecule itself is a straight chain mannan, which is branched at regular intervals with single membered galactose units on alternative mannose units. The mannose units are linked to each other by means of β(1-4) glycosidic linkages. The galactose branching arises by way of an α(1-6) linkage. Cationic derivatives of the guar gums are obtained by reaction between the hydroxyl groups of the polygalactomannan and reactive quaternary ammonium compounds.

The cationic guar polymer may be formed from quaternary ammonium compounds. In an embodiment, the quaternary ammonium compounds for forming the cationic guar polymer conform to the general formula 1:

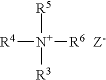

wherein where R³, R⁴ and R⁵ are methyl or ethyl groups; R⁶ is either an epoxyalkyl group of the general formula 2:

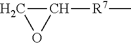

or R⁶ is a halohydrin group of the general formula 3:

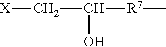

wherein R⁷ is a C₁ to C₃ alkylene; X is chlorine or bromine, and Z is an anion such as Cl—, Br—, I— or HSO₄—.

In an embodiment, the cationic guar polymer conforms to the general formula 4:

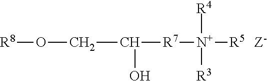

wherein R⁸ is guar gum; and wherein R⁴, R⁵, R⁶ and R⁷ are as defined above; and wherein Z is a halogen. In an embodiment, the cationic guar polymer conforms to Formula 5:

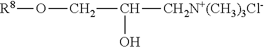

Suitable cationic guar polymers include cationic guar gum derivatives, such as guar hydroxypropyltrimonium chloride. In an embodiment, the cationic guar polymer is a guar hydroxypropyltrimonium chloride. Specific examples of guar hydroxypropyltrimonium chlorides include the Jaguar® series commercially available from Rhone-Poulenc Incorporated, for example Jaguar® C-500, commercially available from Rhodia. Jaguar® C-500 has a charge density of 0.8 meq/g and a M.Wt. of 500,000 g/mole. Jaguar® C-17, which has a cationic charge density of about 0.6 meq/g and a M.Wt. of about 2.2 million g/mol and is available from Rhodia Company. Jaguar® C 13S which has a M.Wt. of 2.2 million g/mol and a cationic charge density of about 0.8 meq/g (available from Rhodia Company). Other suitable guar hydroxypropyltrimonium chloride are: guar hydroxypropyltrimonium chloride which has a charge density of about 1.1 meq/g and a M.Wt. of about 500,000 g/mole is available from ASI, a charge density of about 1.5 meq/g and a M.Wt. of about 500,000 g/mole is available from ASI.

Other suitable guar hydroxypropyltrimonium chloride are: Hi-Care 1000, which has a charge density of about 0.7 meq/g and a M.Wt. of about 600,000 g/mole and is available from Rhodia; N—Hance 3269 and N—Hance 3270, which has a charge density of about 0.7 meq/g and a M.Wt. of about 425,000 g/mole and is available from ASI; N—Hance 3196, which has a charge density of about 0.8 and a M. Wt. of about 1,100,000 g/mole and is available from ASI. AquaCat CG518 has a charge density of about 0.9 meq/g and a M.Wt. of about 50,000 g/mole and is available from ASI. BF-13, which is a borate (boron) free guar of charge density of about 1.1 meq/g and M. W.t of about 800,000 and BF-17, which is a borate (boron) free guar of charge density of about 1.7 meq/g and M. W.t of about 800,000 both available from ASI.

(b) Cationic Non-Guar Galactomannan Polymers

The dispersion compositions of the present invention comprise a galactomannan polymer derivative having a mannose to galactose ratio of between 5:1 and 1:1 on a monomer to monomer basis, the galactomannan polymer derivative selected from the group consisting of a cationic galactomannan polymer derivative and an amphoteric galactomannan polymer derivative having a net positive charge. As used herein, the term “cationic galactomannan” refers to a galactomannan polymer to which a cationic group is added. The term “amphoteric galactomannan” refers to a galactomannan polymer to which a cationic group and an anionic group are added such that the polymer has a net positive charge.

Galactomannan polymers are present in the endosperm of seeds of the Leguminosae family. Galactomannan polymers are made up of a combination of mannose monomers and galactose monomers. The galactomannan molecule is a straight chain mannan branched at regular intervals with single membered galactose units on specific mannose units. The mannose units are linked to each other by means of β (1-4) glycosidic linkages. The galactose branching arises by way of an α (1-6) linkage. The ratio of mannose monomers to galactose monomers varies according to the species of the plant and also is affected by climate. Non Guar Galactomannan polymer derivatives of the present invention have a ratio of mannose to galactose of greater than 2:1 on a monomer to monomer basis. Suitable ratios of mannose to galactose can be greater than about 3:1, and the ratio of mannose to galactose can be greater than about 4:1. Analysis of mannose to galactose ratios is well known in the art and is typically based on the measurement of the galactose content.

The gum for use in preparing the non-guar galactomannan polymer derivatives is typically obtained as naturally occurring material such as seeds or beans from plants. Examples of various non-guar galactomannan polymers include but are not limited to Tara gum (3 parts mannose/1 part galactose), Locust bean or Carob (4 parts mannose/1 part galactose), and Cassia gum (5 parts mannose/1 part galactose).

In one embodiment of the present invention, the galactomannan polymer derivative is a cationic derivative of the non-guar galactomannan polymer, which is obtained by reaction between the hydroxyl groups of the polygalactomannan polymer and reactive quaternary ammonium compounds. Suitable quaternary ammonium compounds for use in forming the cationic galactomannan polymer derivatives include those conforming to the general formulas 1-5, as defined above.

Cationic non-guar galactomannan polymer derivatives formed from the reagents described above are represented by the general formula 6:

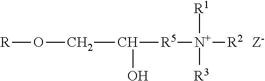

wherein R is the gum. The cationic galactomannan derivative can be a gum hydroxypropyltrimethylammonium chloride, which can be more specifically represented by the general formula 7:

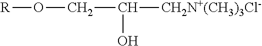

In another embodiment of the invention, the galactomannan polymer derivative is an amphoteric galactomannan polymer derivative having a net positive charge, obtained when the cationic galactomannan polymer derivative further comprises an anionic group.

In one embodiment of the invention the cationic non-guar galactomannan has a ratio of mannose to galactose is greater than about 4:1. The dispersion compositions of the present invention may comprise a galactomannan polymer derivative by weight of the composition. In one embodiment of the present invention, the compositions comprise from about 0.05% to about 2%, by weight of the composition, of a galactomannan polymer derivative.

(c) Cationically Modified Starch Polymer

The dispersion compositions of the present invention comprise water-soluble cationically modified starch polymers. As used herein, the term “cationically modified starch” refers to a starch to which a cationic group is added prior to degradation of the starch to a smaller molecular weight, or wherein a cationic group is added after modification of the starch to achieve a desired molecular weight. The definition of the term “cationically modified starch” also includes amphoterically modified starch. The term “amphoterically modified starch” refers to a starch hydrolysate to which a cationic group and an anionic group are added.

The dispersion compositions of the present invention comprise cationically modified starch polymers at a range of about 0.01% to about 10%, in an embodiment from about 0.01% to about 5%, in an embodiment from about 0.01% to about 1%, by weight of the composition.

The cationically modified starch polymers disclosed herein have a percent of bound nitrogen of from about 0.5% to about 4%.

As used herein, the term “molecular weight” refers to the weight average molecular weight. The weight average molecular weight may be measured by gel permeation chromatography (“GPC”) using a Waters 600E HPLC pump and Waters 717 auto-sampler equipped with a Polymer Laboratories PL Gel MIXED-A GPC column (Part Number 1110-6200, 600.times.7.5 mm, 20 um) at a column temperature of 55.degree. C. and at a flow rate of 1.0 ml/min (mobile phase consisting of Dimethylsulfoxide with 0.1% Lithium Bromide), and using a Wyatt DAWN EOS MALLS (multi-angle laser light scattering detector) and Wyatt Optilab DSP (interferometric refractometer) detectors arranged in series (using a dn/dc of 0.066), all at detector temperatures of 50° C., with a method created by using a Polymer Laboratories narrow dispersed Polysaccharide standard (Mw=47,300), with an injection volume of 200 μl.

The dispersion compositions of the present invention include starch polymers that is chemically modified by the addition of amino and/or ammonium groups into the starch molecules. Non-limiting examples of these ammonium groups may include substituents such as hydroxypropyl trimmonium chloride, trimethylhydroxypropyl ammonium chloride, dimethylstearylhydroxypropyl ammonium chloride, and dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125. The cationic groups may be added to the starch prior to degradation to a smaller molecular weight or the cationic groups may be added after such modification.

The cationically modified starch polymers of the present invention generally have a degree of substitution of a cationic group from about 0.1 to about 7. As used herein, the “degree of substitution” of the cationically modified starch polymers is an average measure of the number of hydroxyl groups on each anhydroglucose unit which is derivatized by substituent groups. Since each anhydroglucose unit has three potential hydroxyl groups available for substitution, the maximum possible degree of substitution is 3. The degree of substitution is expressed as the number of moles of substituent groups per mole of anhydroglucose unit, on a molar average basis. The degree of substitution may be determined using proton nuclear magnetic resonance spectroscopy (“.sup.1H NMR”) methods well known in the art. Suitable .sup.1H NMR techniques include those described in “Observation on NMR Spectra of Starches in Dimethyl Sulfoxide, Iodine-Complexing, and Solvating in Water-Dimethyl Sulfoxide”, Qin-Ji Peng and Arthur S. Perlin, Carbohydrate Research, 160 (1987), 57-72; and “An Approach to the Structural Analysis of Oligosaccharides by NMR Spectroscopy”, J. Howard Bradbury and J. Grant Collins, Carbohydrate Research, 71, (1979), 15-25.

The source of starch before chemical modification can be chosen from a variety of sources such as tubers, legumes, cereal, and grains. Non-limiting examples of this source starch may include corn starch, wheat starch, rice starch, waxy corn starch, oat starch, cassaya starch, waxy barley, waxy rice starch, glutenous rice starch, sweet rice starch, amioca, potato starch, tapioca starch, oat starch, sago starch, sweet rice, or mixtures thereof.

In one embodiment of the present invention, cationically modified starch polymers are selected from degraded cationic maize starch, cationic tapioca, cationic potato starch, and mixtures thereof. In another embodiment, cationically modified starch polymers are cationic corn starch and cationic tapioca.

The starch, prior to degradation or after modification to a smaller molecular weight, may comprise one or more additional modifications. For example, these modifications may include cross-linking, stabilization reactions, phosphorylations, and hydrolyzations. Stabilization reactions may include alkylation and esterification.

The cationically modified starch polymers in the present invention may be incorporated into the composition in the form of hydrolyzed starch (e.g., acid, enzyme, or alkaline degradation), oxidized starch (e.g., peroxide, peracid, hypochlorite, alkaline, or any other oxidizing agent), physically/mechanically degraded starch (e.g., via the thermo-mechanical energy input of the processing equipment), or combinations thereof.

An optimal form of the starch is one which is readily soluble in water and forms a substantially clear (% Transmittance≧80 at 600 nm) solution in water. The transparency of the composition is measured by Ultra-Violet/Visible (UV/VIS) spectrophotometry, which determines the absorption or transmission of UV/VIS light by a sample, using a Gretag Macbeth Colorimeter Color i 5 according to the related instructions. A light wavelength of 600 nm has been shown to be adequate for characterizing the degree of clarity of cosmetic compositions.

Suitable cationically modified starch for use in compositions of the present invention is available from known starch suppliers. Also suitable for use in the present invention is nonionic modified starch that could be further derivatized to a cationically modified starch as is known in the art. Other suitable modified starch starting materials may be quaternized, as is known in the art, to produce the cationically modified starch polymer suitable for use in the invention.

Starch Degradation Procedure: In one embodiment of the present invention, a starch slurry is prepared by mixing granular starch in water. The temperature is raised to about 35° C. An aqueous solution of potassium permanganate is then added at a concentration of about 50 ppm based on starch. The pH is raised to about 11.5 with sodium hydroxide and the slurry is stirred sufficiently to prevent settling of the starch. Then, about a 30% solution of hydrogen peroxide diluted in water is added to a level of about 1% of peroxide based on starch. The pH of about 11.5 is then restored by adding additional sodium hydroxide. The reaction is completed over about a 1 to about 20 hour period. The mixture is then neutralized with dilute hydrochloric acid. The degraded starch is recovered by filtration followed by washing and drying.

(d) Cationic Copolymer of an Acrylamide Monomer and a Cationic Monomer

According to an embodiment of the present invention, the dispersion composition comprises a cationic copolymer of an acrylamide monomer and a cationic monomer. In an embodiment, the cationic copolymer is a synthetic cationic copolymer of acrylamide monomers and cationic monomers.

In an embodiment, the cationic copolymer comprises:

(i) An Acrylamide Monomer of the Following Formula AM:

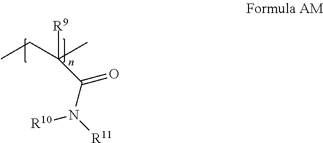

where R⁹ is H or C₁₋₄ alkyl; and R¹⁰ and R¹¹ are independently selected from the group consisting of H, C₁₋₄ alkyl, CH₂OCH₃, CH₂OCH₂CH(CH₃)₂, and phenyl, or together are C₃₋₆cycloalkyl; and

(ii) A Cationic Monomer Conforming to Compound CM:

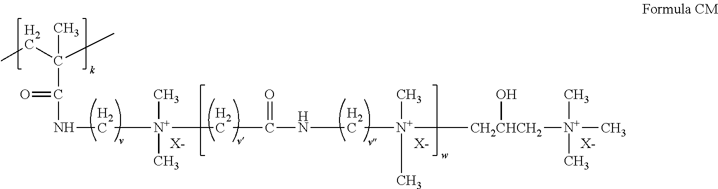

where k=1, each of v, v′, and v″ is independently an integer of from 1 to 6, w is zero or an integer of from 1 to 10, and X⁻ is an anion.

In an embodiment, cationic monomer conforming to Formula CM and where k=1, v=3 and w=0, z=1 and X⁻ is Cl⁻ to form the following structure:

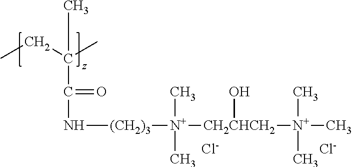

The above structure may be referred to as diquat. In another embodiment, the cationic monomer conforms to Formula CM and wherein v and v″ are each 3, v′=1, w=1, y=1 and X⁻ is Cl⁻, such as:

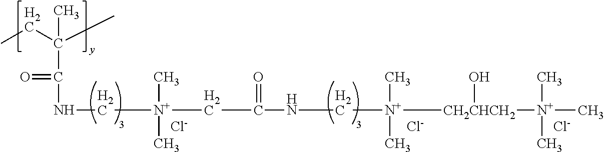

The above structure may be referred to as triquat.

In an embodiment, the acrylamide monomer is either acrylamide or methacrylamide.

In an embodiment, the cationic copolymer (b) is AM:TRIQUAT which is a copolymer of acrylamide and 1,3-Propanediaminium,N-[2-[[[dimethyl[3-[(2-methyl-1-oxo-2-propenyl)amino]propyl]ammonio]acetyl]amino]ethyl]2-hydroxy-N,N,N′,N′,N′-pentamethyl-, trichloride. AM:TRIQUAT is also known as polyquaternium 76 (PQ76). AM:TRIQUAT may have a charge density of 1.6 meq/g and a M.Wt. of 1.1 million g/mol.

In an alternative embodiment, the cationic copolymer is of an acrylamide monomer and a cationic monomer, wherein the cationic monomer is selected from the group consisting of: dimethylaminoethyl(meth)acrylate, dimethylaminopropyl(meth)acrylate, ditertiobutylaminoethyl(meth)acrylate, dimethylaminomethyl(meth)acrylamide, dimethylaminopropyl(meth)acrylamide; ethylenimine, vinylamine, 2-vinylpyridine, 4-vinylpyridine; trimethylammonium ethyl(meth)acrylate chloride, trimethylammonium ethyl(meth)acrylate methyl sulphate, dimethylammonium ethyl(meth)acrylate benzyl chloride, 4-benzoylbenzyl dimethylammonium ethyl acrylate chloride, trimethyl ammonium ethyl(meth)acrylamido chloride, trimethyl ammonium propyl(meth)acrylamido chloride, vinylbenzyl trimethyl ammonium chloride, diallyldimethyl ammonium chloride, and mixtures thereof.

In an embodiment, the cationic copolymer comprises a cationic monomer selected from the group consisting of: cationic monomers include trimethylammonium ethyl(meth)acrylate chloride, trimethylammonium ethyl(meth)acrylate methyl sulphate, dimethylammonium ethyl(meth)acrylate benzyl chloride, 4-benzoylbenzyl dimethylammonium ethyl acrylate chloride, trimethyl ammonium ethyl(meth)acrylamido chloride, trimethyl ammonium propyl(meth)acrylamido chloride, vinylbenzyl trimethyl ammonium chloride, and mixtures thereof.

In an embodiment, the cationic copolymer is water-soluble. In an embodiment, the cationic copolymer is formed from (1) copolymers of (meth)acrylamide and cationic monomers based on (meth)acrylamide, and/or hydrolysis-stable cationic monomers, (2) terpolymers of (meth)acrylamide, monomers based on cationic (meth)acrylic acid esters, and monomers based on (meth)acrylamide, and/or hydrolysis-stable cationic monomers. Monomers based on cationic (meth)acrylic acid esters may be cationized esters of the (meth)acrylic acid containing a quaternized N atom. In an embodiment, cationized esters of the (meth)acrylic acid containing a quaternized N atom are quaternized dialkylaminoalkyl(meth)acrylates with C1 to C3 in the alkyl and alkylene groups. In an embodiment, the cationized esters of the (meth)acrylic acid containing a quaternized N atom are selected from the group consisting of: ammonium salts of dimethylaminomethyl(meth)acrylate, dimethylaminoethyl(meth)acrylate, dimethylaminopropyl (meth)acrylate, diethylaminomethyl(meth)acrylate, diethylaminoethyl(meth)acrylate; and diethylaminopropyl(meth)acrylate quaternized with methyl chloride. In an embodiment, the cationized esters of the (meth)acrylic acid containing a quaternized N atom is dimethylaminoethyl acrylate, which is quaternized with an alkyl halide, or with methyl chloride or benzyl chloride or dimethyl sulfate (ADAME-Quat). In an embodiment, the cationic monomer when based on (meth)acrylamides are quaternized dialkylaminoalkyl(meth)acrylamides with C1 to C3 in the alkyl and alkylene groups, or dimethylaminopropylacrylamide, which is quaternized with an alkyl halide, or methyl chloride or benzyl chloride or dimethyl sulfate.

In an embodiment, the cationic monomer based on a (meth)acrylamide is a quaternized dialkylaminoalkyl(meth)acrylamide with C1 to C3 in the alkyl and alkylene groups. In an embodiment, the cationic monomer based on a (meth)acrylamide is dimethylaminopropylacrylamide, which is quaternized with an alkyl halide, especially methyl chloride or benzyl chloride or dimethyl sulfate.

In an embodiment, the cationic monomer is a hydrolysis-stable cationic monomer. Hydrolysis-stable cationic monomers can be, in addition to a dialkylaminoalkyl(meth)acrylamide, all monomers that can be regarded as stable to the OECD hydrolysis test. In an embodiment, the cationic monomer is hydrolysis-stable and the hydrolysis-stable cationic monomer is selected from the group consisting of: diallyldimethylammonium chloride and water-soluble, cationic styrene derivatives.

In an embodiment, the cationic copolymer is a terpolymer of acrylamide, 2-dimethylammoniumethyl(meth)acrylate quaternized with methyl chloride (ADAME-Q) and 3-dimethylammoniumpropyl(meth)acrylamide quaternized with methyl chloride (DIMAPA-Q). In an embodiment, the cationic copolymer is formed from acrylamide and acrylamidopropyltrimethylammonium chloride, wherein the acrylamidopropyltrimethylammonium chloride has a charge density of from about 1.0 meq/g to about 3.0 meq/g.

In an embodiment, the cationic copolymer is a trimethylammoniopropylmethacrylamide chloride-N-Acrylamide copolymer, which is also known as AM:MAPTAC. AM:MAPTAC may have a charge density of about 1.3 meq/g and a M.Wt. of about 1.1 million g/mol. In an embodiment, the cationic copolymer is AM:ATPAC. AM:ATPAC may have a charge density of about 1.8 meq/g and a M.Wt. of about 1.1 million g/mol.

(e) Cationic Synthetic Polymer

According to an embodiment of the present invention, the dispersion composition comprises a cationic synthetic polymer that may be formed from

i) one or more cationic monomer units, and optionally

ii) one or more monomer units bearing a negative charge, and/or

iii) a nonionic monomer,

wherein the subsequent charge of the copolymer is positive. The ratio of the three types of monomers is given by “m”, “p” and “q” where “m” is the number of cationic monomers, “p” is the number of monomers bearing a negative charge and “q” is the number of nonionic monomers

In one embodiment, the cationic polymers are water soluble or dispersible, non-crosslinked, synthetic cationic polymers having the following structure:

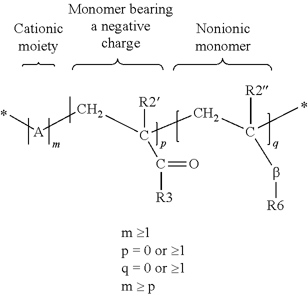

where A, may be one or more of the following cationic moieties:

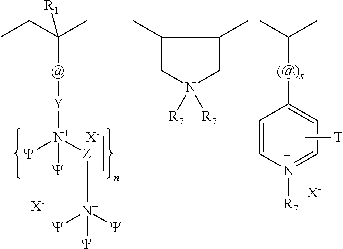

where @=amido, alkylamido, ester, ether, alkyl or alkylaryl;
where Y=C1-C22 alkyl, alkoxy, alkylidene, alkyl or aryloxy;
where ψ=C1-C22 alkyl, alkyloxy, alkyl aryl or alkyl arylox;
where Z=C1-C22 alkyl, alkyloxy, aryl or aryloxy;
where R1=H, C1-C4 linear or branched alkyl;
where s=0 or 1, n=0 ≧or 1;
where T and R7=C1-C22 alkyl; and
where X−=halogen, hydroxide, alkoxide, sulfate or alkylsulfate.

Where the monomer bearing a negative charge is defined by R2′=H, C1-C4 linear or branched alkyl and R3 as:

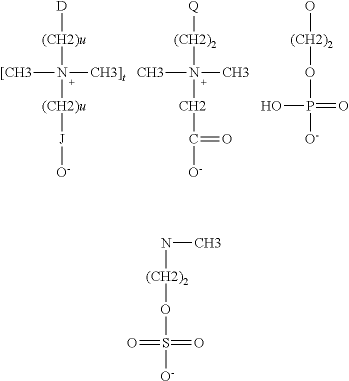

where D=O, N, or S;
where Q=NH₂ or O;
where u=1-6;
where t=0-1; and
where J=oxygenated functional group containing the following elements P, S, C.

Where the nonionic monomer is defined by R2″=H, C1-C4 linear or branched alkyl, R6=linear or branched alkyl, alkyl aryl, aryl oxy, alkyloxy, alkylaryl oxy and β is defined as

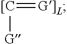

and
where G′ and G″ are, independently of one another, O, S or N—H and L=0 or 1.

Examples of cationic monomers include aminoalkyl(meth)acrylates, (meth)aminoalkyl(meth)acrylamides; monomers comprising at least one secondary, tertiary or quaternary amine function, or a heterocyclic group containing a nitrogen atom, vinylamine or ethylenimine; diallyldialkyl ammonium salts; their mixtures, their salts, and macromonomers deriving from therefrom.

Further examples of cationic monomers include dimethylaminoethyl(meth)acrylate, dimethylaminopropyl(meth)acrylate, ditertiobutylaminoethyl(meth)acrylate, dimethylaminomethyl(meth)acrylamide, dimethylaminopropyl(meth)acrylamide, ethylenimine, vinylamine, 2-vinylpyridine, 4-vinylpyridine, trimethylammonium ethyl(meth)acrylate chloride, trimethylammonium ethyl(meth)acrylate methyl sulphate, dimethylammonium ethyl(meth)acrylate benzyl chloride, 4-benzoylbenzyl dimethylammonium ethyl acrylate chloride, trimethyl ammonium ethyl(meth)acrylamido chloride, trimethyl ammonium propyl(meth)acrylamido chloride, vinylbenzyl trimethyl ammonium chloride, diallyldimethyl ammonium chloride.

Suitable cationic monomers include those which comprise a quaternary ammonium group of formula —NR₃⁺, wherein R, which is identical or different, represents a hydrogen atom, an alkyl group comprising 1 to 10 carbon atoms, or a benzyl group, optionally carrying a hydroxyl group, and comprise an anion (counter-ion). Examples of anions are halides such as chlorides, bromides, sulphates, hydrosulphates, alkylsulphates (for example comprising 1 to 6 carbon atoms), phosphates, citrates, formates, and acetates.

Suitable cationic monomers include trimethylammonium ethyl(meth)acrylate chloride, trimethylammonium ethyl(meth)acrylate methyl sulphate, dimethylammonium ethyl(meth)acrylate benzyl chloride, 4-benzoylbenzyl dimethylammonium ethyl acrylate chloride, trimethyl ammonium ethyl(meth)acrylamido chloride, trimethyl ammonium propyl(meth)acrylamido chloride, vinylbenzyl trimethyl ammonium chloride.

Additional suitable cationic monomers include trimethyl ammonium propyl(meth)acrylamido chloride. In one embodiment the cationic polymer is polydiallyldimethylammonium chloride (PolyDADMAC—specifically polyquaternium 6).

Examples of monomers bearing a negative charge include alpha ethylenically unsaturated monomers comprising a phosphate or phosphonate group, alpha ethylenically unsaturated monocarboxylic acids, monoalkylesters of alpha ethylenically unsaturated dicarboxylic acids, monoalkylamides of alpha ethylenically unsaturated dicarboxylic acids, alpha ethylenically unsaturated compounds comprising a sulphonic acid group, and salts of alpha ethylenically unsaturated compounds comprising a sulphonic acid group.

Suitable monomers with a negative charge include acrylic acid, methacrylic acid, vinyl sulphonic acid, salts of vinyl sulfonic acid, vinylbenzene sulphonic acid, salts of vinylbenzene sulphonic acid, alpha-acrylamidomethylpropanesulphonic acid, salts of alpha-acrylamidomethylpropanesulphonic acid, 2-sulphoethyl methacrylate, salts of 2-sulphoethyl methacrylate, acrylamido-2-methylpropanesulphonic acid (AMPS), salts of acrylamido-2-methylpropanesulphonic acid, and styrenesulphonate (SS).

Examples of nonionic monomers include vinyl acetate, amides of alpha ethylenically unsaturated carboxylic acids, esters of an alpha ethylenically unsaturated monocarboxylic acids with an hydrogenated or fluorinated alcohol, polyethylene oxide(meth)acrylate (i.e. polyethoxylated(meth)acrylic acid), monoalkylesters of alpha ethylenically unsaturated dicarboxylic acids, monoalkylamides of alpha ethylenically unsaturated dicarboxylic acids, vinyl nitriles, vinylamine amides, vinyl alcohol, vinyl pyrolidone, and vinyl aromatic compounds.

Suitable nonionic monomers include styrene, acrylamide, methacrylamide, acrylonitrile, methylacrylate, ethylacrylate, n-propylacrylate, n-butylacrylate, methylmethacrylate, ethylmethacrylate, n-propylmethacrylate, n-butylmethacrylate, 2-ethyl-hexyl acrylate, 2-ethyl-hexyl methacrylate, 2-hydroxyethylacrylate and 2-hydroxyethylmethacrylate.

The anionic counterion (X−) in association with the synthetic cationic polymers may be any known counterion so long as the polymers remain soluble or dispersible in water, in a a composition, or in a coacervate phase of a composition, and so long as the counterions are physically and chemically compatible with the essential components of the composition or do not otherwise unduly impair product performance, stability or aesthetics. Non limiting examples of such counterions include halides (e.g., chlorine, fluorine, bromine, iodine), sulfate and methylsulfate.

(f). Cationic Cellulose Polymers

Suitable cationic cellulose polymers are salts of hydroxyethyl cellulose reacted with trimethyl ammonium substituted epoxide, referred to in the industry (CTFA) as Polyquaternium 10 and available from Dow/Amerchol Corp. (Edison, N.J., USA) in their Polymer LR, JR, and KG series of polymers. Other suitable types of cationic cellulose include the polymeric quaternary ammonium salts of hydroxyethyl cellulose reacted with lauryl dimethyl ammonium-substituted epoxide referred to in the industry (CTFA) as Polyquaternium 24. These materials are available from Dow/Amerchol Corp. under the tradename Polymer LM-200. Other suitable types of cationic cellulose include the polymeric quaternary ammonium salts of hydroxyethyl cellulose reacted with lauryl dimethyl ammonium-substituted epoxide and trimethyl ammonium substituted epoxide referred to in the industry (CTFA) as Polyquaternium 67. These materials are available from Dow/Amerchol Corp. under the tradename SoftCAT Polymer SL-5, SoftCAT Polymer SL-30, Polymer SL-60, Polymer SL-100, Polymer SK-L, Polymer SK-M, Polymer SK-MH, and Polymer SK-H.

C. Anionic Surfactant

In an embodiment, the present invention may comprise an anionic surfactant. In an embodiment, the anionic surfactant may comprise an anion selected from the group consisting of sulfates, sulfonates, sulfosuccinates, isethionates, carboxylates, phosphates, and phosphonates.

In an embodiment, the anionic surfactant may be a sodium polynaphthalenesulfonate, a non-limiting example is Darvan from R.T. Vanderbilt Company, Inc

In a further embodiment, the anionic surfactant may be an alkyl sulfate or an alkyl ether sulfate. These materials have the respective formulae R⁹OSO₃M and R⁹O(C₂H₄O)ₓSO₃M, wherein R⁹ is alkyl or alkenyl of from about 8 to about 18 carbon atoms, x is an integer having a value of from about 1 to about 10, and M is a cation such as ammonium, an alkanolamine such as triethanolamine, a monovalent metal cation such as sodium and potassium, or a polyvalent metal cation such as magnesium and calcium. Solubility of the surfactant will depend upon the particular anionic surfactants and cations chosen. In an embodiment, R⁹ has from about 8 to about 18 carbon atoms, or from about 10 to about 16 carbon atoms, or from about 12 to about 14 carbon atoms, in both the alkyl sulfates and alkyl ether sulfates. The alkyl ether sulfates are typically made as condensation products of ethylene oxide and monohydric alcohols having from about 8 to about 24 carbon atoms. The alcohols can be synthetic or they can be derived from fats, e.g., coconut oil, palm kernel oil, tallow. In an embodiment, the alcohols are lauryl alcohol and straight chain alcohols derived from coconut oil or palm kernel oil. Such alcohols are reacted with from about 0 to about 10, or from about 2 to about 5, or about 3, molar proportions of ethylene oxide, and the resulting mixture of molecular species having, for example, an average of 3 moles of ethylene oxide per mole of alcohol is sulfated and neutralized. In an embodiment, the alkyl ether sulphate is selected from the group consisting of: sodium and ammonium salts of coconut alkyl triethylene glycol ether sulfate, tallow alkyl triethylene glycol ether sulfate, tallow alkyl hexa-oxyethylene sulphate, and mixtures thereof. In an embodiment, the alkyl ether sulfate comprises a mixture of individual compounds, wherein the compounds in the mixture have an average alkyl chain length of from about 10 to about 16 carbon atoms and an average degree of ethoxylation of from about 1 to about 4 moles of ethylene oxide. Such a mixture also comprises from about 0% to about 20% C₁₂₋₁₃ compounds; from about 60% to about 100% of C₁₄₋₁₅₋₁₆ compounds; from about 0% to about 20% by weight of C₁₇₋₁₈₋₁₉ compounds; from about 3% to about 30% by weight of compounds having a degree of ethoxylation of 0; from about 45% to about 90% by weight of compounds having a degree of ethoxylation from about 1 to about 4; from about 10% to about 25% by weight of compounds having a degree of ethoxylation from about 4 to about 8; and from about 0.1% to about 15% by weight of compounds having a degree of ethoxylation greater than about 8.

In an embodiment, non-limiting examples of an anionic surfactant are ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, triethanolamine lauryl sulfate, monoethanolamine cocoyl sulfate, monoethanolamine lauryl sulfate, and mixtures thereof. In addition to the sulfates, isethionates, sulfonates, sulfosuccinates described above, other potential anions for the anionic surfactant include phosphonates, phosphates, and carboxylates.

In the present invention, an anionic surfactant may be present in the range of about 0.01% to about 2.0%, in another embodiment in the range of about 0.05% to about 1.75%, in another embodiment in the range of about 0.08% to about 1.25%

D. Other Materials

The dispersion composition may comprise other materials than non-cationic polymers. Non-limiting examples of these materials are:
1. Homopolymers based on acrylic acid, methacrylic acid or other related derivatives such as for examples, polyacrylate, polymethacrylate, polyethylacrylate, and polyacrylamide.
2. Alkali swellable and hydrophobically-modified alkali swellable acrylic copolymers or methacrylate copolymers such as, for example, acrylic acid/acrylonitrogens copolymer, acrylates/steareth-20 itaconate copolymer, acrylates/ceteth-20 itaconate copolymer, acrylates/aminoacrylates copolymer, acrylates/steareth-20 methacrylate copolymer, acrylates/beheneth-25 methacrylate copolymer, acrylates/steareth-20 methacrylate crosspolymer, acrylates/vinylneodecanoate crosspolymer, and acrylates/C10-C30 alkyl acrylate crosspolymer.
3. Soluble crosslinked acrylic polymers, a non-limiting example is carbomers.
4. Alginic acid based materials, non-liming examples such as sodium alginate, and alginic acid propylene glycol esters.
5. Associative polymeric thickeners is an important class of rheology modifiers. It includes a variety of material classes, non-limiting examples are:
a. Hydrophobically modified cellulose derivatives;
b. hydrophobically modified alkoxylated urethane polymers, such as PEG-150/decyl alcohol/SMDI copolymer, PEG-150/stearyl alcohol/SMDI copolymer, polyurethane-39;
c. Hydrophobically modified, alkali swellable emulsions, such as hydrophobically modified polypolyacrylates, hydrophobically modified polyacrylic acids, and hydrophobically modified polyacrylamides;
d. Hydrophobically modified polyethers. This class of materials includes numerous members. Typically these materials have a hydrophobe that can be selected from cetyl, stearyl, oleayl, and combinations thereof, and a hydrophilic portion of repeating ethylene oxide groups with repeat units from 10-300, more preferably from 30-200, more preferably from 40-150. Non-limiting examples of this class include PEG-120-methylglucose dioleate, PEG-(40 or 60) sorbitan tetraoleate, PEG-150 pentaerythrityl tetrastearate, PEG-55 propylene glycol oleate, PEG-150 distearate.
6. Cellulose and derivatives, non-limiting examples include a. Microcrystalline cellulose; b. Carboxymethylcelluloses; c. Hydroxyethylcellulose; d. Hydroxypropylcellulose; e. Hydroxypropylmethylcellulose; f. Methylcellulose; g. ethyl cellulose; h. nitro cellulose; i. cellulose sulfate; j. cellulose powder; k. Hydrophobically modified celluloses
7. Polyethylene Oxide or Polypropyne oxide or POE-PPO copolymers
8. Polyvinylpyrrolidone, crosslinked polyvinylpyrrolidone and derivatives.
9. Polyvinyalcohol and derivatives.
10. Polyethyleneimine and derivatives.
11. Silicas, non-limiting examples include fumed silica, precipitated silica, and silicone-surface treated silica.
12. Water-swellable Clays, non-limiting examples include laponite, bentolite, montmorilonite, smectite, and hectonite.
13. Gums, non-limiting examples include xanthan gum, guar gum, hydroxypropyl guar gum, Arabia gum, tragacanth, galactan, carob gum, karaya gum, and locust bean gum.
14. Other materials, non-limiting examples include dibenzylidene sorbitol, karaggenan, pectin, agar, quince seed (Cydonia oblonga Mill), starch (from rice, corn, potato, wheat, etc), starch-derivatives (e.g. carboxymethyl starch, methylhydroxypropyl starch), algae extracts, dextran, succinoglucan, and pulleran, 15) ethyleneglycoldistearate particles hydrogenated castor oil.

### Dispersants

In an embodiment of the present invention, a dispersant may be present. Typically, small particle dispersions require stabilization to prevent particle aggregation/agglomeration and also stabilization to prevent particle settling. The former is achieved by the presence of one or more surfactants or one or more polymeric dispersant which protect the particles sterically and/or electrostatically. The latter is achieved by the presence of a rheology modifier, which increases the viscosity especially in the low shear range.

Steric and/or electrostatic particle protection can be achieved by the addition in the dispersion compositions of anionic, non-ionic, cationic, amphoteric, zwitterionic surfactants or polymeric dispersants. Typically, polymeric dispersant molecules comprise of functional groups that anchor on the particle and functional groups that are compatible with the carrier of the dispersion Anchoring group is a selected from non-limiting examples such as carboxyls, carboxylic acid esters, hydroxyls, sulfonates, sulfates, phosphates, phosphonates, nitros, carbohydrates, ammonium salts, phosphate esters, carbonyls, aminos, amides, imides, aliphatic hydrocarbons, aromatic hydrocarbons, heterocyclic groups, polypropyleneoxides, silicones, fluorocarbons, polyesters, urethanes and mixtures thereof,

The stabilizing group is selected from non-limiting examples such as polyethyleneoxide, polyethylene glycols, polypropylene glycol, polyethylene glycol alkyl, alkyl glycols, alkyl glycol ether, polyethylene glycol esters, polyalkylene oxide, polypropyleneoxides, polyglycerides, carboxyl, carboxylic acid esters, hydroxyl, sulfonate, sulfate, phosphate, phosphonate, nitro, carbohydrate, ammonium salts, phosphate esters, carbonyl, amino, amide, imide, aliphatic hydrocarbons, aromatic hydrocarbons, heterocyclic groups, polypropyleneoxides, silicones, fluorocarbons, polyesters and mixtures thereof.

In a further embodiment of the present invention, the compositions may contain inorganic salts, nonlimiting examples such as sodium chloride, zinc carbonate, as well as containing conventional preservatives. In an embodiment, inorganic salts may be present in the range of about 0.1% to 5%, in a further embodiment in the range of about 0.5% to 3%.

### Experimental Section

The exemplified aqueous ZPT dispersion compositions can be prepared using conventional formulation and dispersing techniques known to a person having ordinary skill in the art. The equipment used may include high speed dispersers or other milling equipment such as media mills. A typical procedure includes dispersing the ZPT particles in aqueous solution of anionic surfactant or mixture of surfactants.

The addition of the cationic polymer can be performed before or after the dispersing step. In the case of the post-addition, the cationic polymer may need to be added in portions over a period of several minutes or longer, followed by post-addition mixing in order to achieve uniform dispersion.

TABLE 1
Experimental Results.- Summary

| | Experi- | Experi- | Experi- | Experi- | Experi- | Experi- |
|---|---|---|---|---|---|---|
| Ingredients | ment 1 | ment 2 | ment 3 | ment 4 | ment 5 | ment 6 |
| Zinc pyrithione | 40.0 | 40.0 | 40.0 | 40.0 | 40.0 | 40.0 |
| Sodium | 0.16 | 0.16 | 0.16 | | | 0.16 |
| polynaphthalenesulfonate | | | | | | |
| (Note 1) | | | | | | |
| Guar | | 0.10 | 0.05 | | 0.10 | |
| Hydroxypropyltrimonium | | | | | | |
| chloride (Note 2) | | | | | | |
| Guar Gum (Note 3) | | | | | | 0.10 |
| Sodium chloride | 1.6 | 1.6 | 1.6 | 1.6 | 1.6 | 1.6 |
| Preservatives | 0.1 | 0.1 | 0.1 | 0.1 | 0.1 | 0.1 |
| Water | QS | QS | QS | QS | QS | QS |
| Phase stability via | 0.5 | 2.3 | 2.3 | 0.7 | 0.8 | Not possible to |
| inspection 24 hours after | | | | | | measure due to the |
| dispersion preparation. | | | | | | formation of very |
| Ratio of the height of the | | | | | | large agglomerated |
| dispersed opaque layer: | | | | | | pieces of solid |
| Height of the supernatant | | | | | | throughout the |
| transparent layer | | | | | | dispersion volume. |
| Phase stability via | 0.5 | 2.3 | | | | |
| inspection 1 week after | | | | | | |
| dispersion preparation | | | | | | |
| Ratio of the height of the | | | | | | |
| dispersed opaque layer: | | | | | | |
| Height of the supernatant | | | | | | |
| transparent layer | | | | | | |
| Phase stability via | 0.7 | 2.3 | | | | |
| inspection 3 months after | | | | | | |
| dispersion preparation | | | | | | |
| Ratio of the height of the | | | | | | |
| dispersed opaque layer: | | | | | | |
| Height of the supernatant | | | | | | |
| transparent layer | | | | | | |
| Rate of particle settling | 2.20 | 1.94 | 2.06 | Not | Not | Not |
| measured at 1 week after | mm/day | mm/day | mm/day | Analyzed | Analyzed | Analyzed |
| dispersion preparation | | | | | | |
| (via turbidity/Lumisizer) | | | | | | |
| Cake hardness measured | 0.10 | 0.16 | 0.24 | 0.00 | Not | Not |
| 1 week after dispersion | cm | cm | cm | cm | Analyzed | Analyzed |
| preparation. Measured by | | | | | | |
| the level of penetration | | | | | | |
| of a stick inside the | | | | | | |
| settled cake | | | | | | |
| Ease of redispersion. | Rating | Rating | Rating | Rating | Rating | Not possible to |
| Estimated after jar | 3 | 1 | 1 | 5 | 5 | measure due to the |
| inversion | Hard | Very soft | Very soft | Very hard | Very hard | formation of very |
| | cake | cake | cake | cake | cake | large agglomerated |
| | | | | | | pieces of solid |
| | | | | | | throughout the |
| | | | | | | dispersion volume |

Note 1:
Darvan lot S1254 supplied by R. T. Vanderbilt Company, Inc
Note 2:
Jaguar C500, lot 95961379s-023 supplied by Rhodia
Note 3:
Jaguar S, lot H1201044A supplied by Rhodia

### Characterization Methods:

The compositions are evaluated using the methodologies described below.

### Phase Stability in Terms of Separation of the Dispersion in Two Layers (After 24 Hours and 3 Months)

This test measures the level of separation/settling of the particles in the aqueous medium. Stable dispersions appear more uniform over time. Unstable dispersions appear having a long, clear supernatant layer over time. The opaque layer corresponds to dispersed/settled layer and the transparent layer corresponds to the supernatant carrier layer. The ratio of the height of the dispersed opaque layer: Height of the supernatant transparent layer has a direct correlation with the stability of the dispersion. The larger the ratio of the height of the opaque layer over the height of the clear supernatant layer, the more stable the dispersion is.

### Rate of Particle Settling (Measured Via LUMisizer)

The Lumifuge/Lumisizer instrument employs the STEP technology, which allows us to measure the intensity of the transmitted light as a function of time and position over the full sample length simultaneously. The LUMisizer measures the rate of settling of suspended particles (non-continuous media) in a continuous media in real time, and is used to predict shelf life. The transmission profiles are representative for the variation of particle concentration inside the sample (low transmission means high particle concentration, high transmission means low particle concentration).

### Cake Hardness

It relates to the degree of consolidation of the settled particle cake. This is a semi-quantitative test that measures the resistance that a light plastic stick of diameter of 3 mm, length of 13.5 cm and weight of 0.2 g faces when it is dropped on the settled particle cake. If the stick passes through the cake all the way to the bottom of the container, then the cake is soft, and the settled material can be easily redispersed using gentle mixing. On the contrary, if the stick only slightly penetrates into the cake, the cake hardness is high and the settled material will require strong agitation to redisperse. Thus, the distance of the stick penetration of the cake (in cm) corresponds to cake hardness. The higher the penetration of the stick, the softer and more redispersible the cake is.

### Ease of Redispersion

This is a visual test that qualitatively allows the estimation of the ease of the particles to be redispersed in the medium after settling. The test consists of inverting a bottle of previously settled dispersion, and visually assessing how much of the settled material redisperses back into the medium. An easy-to-redisperse material will redisperse leaving none or very little residue on the bottom of the flask, while unstable and difficult-to-redisperse material will form a tough-to-remove cake and will not redisperse into the medium. Table 2 describes the 1-4 rating scale used to rate the ease of redispersion of ZPT dispersions.

TABLE 2

| Rating of ease-of- | |
|---|---|
| redispersion | Comments |
| 1 | Very soft settled cake; substantially all the cake |
| | is redispersed after jar inversion |
| 2 | Soft cake; a very small layer of the cake stays |
| | separated from the carrier after jar inversion |
| 3 | Hard cake; more than half of the cake stays |
| | separated from the carrier even jar inversion |
| 4 | Very hard cake; substantially all the cake stays |
| | separated from the carrier even after stirring. |

Preparation

A quantity of 500 g of each dispersion that corresponds to the compositions of Experiments 1-6 is prepared and separated into 5 equal portions of 100 g, inserted into glass jars and kept at room temperature for a certain time period. The jars are marked as:

T0 (tested within 15 minutes after preparation of the dispersion);

T1 (tested at 24 hours after preparation of the dispersion);

T2 (tested at 1 week after preparation of the dispersion);

T3 (tested at 3 months after preparation of the dispersion).

The results of Table 1 indicate that:
a. ZPT cannot be successfully dispersed in a aqueous medium alone without dispersion/settling stability additives such as surfactants and polymers (see results of Experiment 4).
b. Anionic surfactant is necessary to achieve phase stability and easily redispersed ZPT dispersion (see results of Experiments 2 and 3 versus Experiment 4 and 5.
c. However, as the results of Experiments 2 and 3 versus Experiment 1 indicates, the presence of anionic surfactant is not sufficient by itself to achieve dispersion stability and the presence of a cationically-modified guar polymer (in combination with the anionic surfactant) is required.
d. Cationically-modified guar (without the presence of anionic surfactant) is also not sufficient to provide dispersion stability (see Experiment 2 and 3 versus Experiment 5).
e. Replacement of cationically-modified guar with non-cationic guar cannot achieve the required stability (see results of Experiment 2 versus Experiment 6).

Without being limited by theory, the results of this investigation indicate that for a stable ZPT dispersion one needs to develop compositions containing dispersing and rheology additives. Dispersants prevent aggregation/agglomeration of the particles and rheology modifiers are required to prevent particle settling. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
a) from about 25% to about 60% of a pyrithione or polyvalent metal salt of a pyrithione;
b) from about 0.01 to about 1% of a cationic polymer;
c) from about 0.01% to about 2.0% of an anionic surfactant;
wherein the cationic polymer has a molecular weight from about 100,000 to about 2,000,000.

2. A composition according to claim 1 wherein the pyrithione or polyvalent metal salt of a pyrithione is from about 30% to about 50%.

3. A composition according to claim 1 wherein the pyrithione or polyvalent metal salt of a pyrithione is zinc pyrithione.

4. A composition according to claim 1 wherein the cationic polymer is from about 0.05% to about 0.3%.

5. A composition according to claim 1 wherein the anionic surfactant is from about 0.08% to about 1.25%.

6. A composition according to claim 1 wherein the anionic surfactant is a sodium polynaphthalenesulfonate.

7. A composition according to claim 1 wherein the cationic polymer is from about 200,000 to about 700,000.

8. A composition according to claim 1 wherein the cationic polymer is from about 300,000 to about 500,000.

9. A composition according to claim 1 wherein the composition has a settling rate of less than 2.1 mm/day.

10. A composition according to claim 1 wherein the cationic polymer is selected from the group consisting of galactomanan, modified galactommans, cellulosics, modified cellulosics, starches, and mixtures thereof.

11. A composition according to claim 1 wherein the galactoman comprises fenugreek gum (galactose:mannose ratio 1:1), guar gum (ratio 1:2), tara gum (ratio 1:3), locust bean (ratio 1:4), cassia (ratio 1:5) and mixtures thereof.

12. A composition according to claim 1 wherein the starch is selected from the group consisting of corn, rice, potato, tapioca, and mixtures thereof.

13. A composition according to claim 1 wherein the synthetic polymer is selected from the group consisting of a copolymer of acrylamide and 1,3-Propanediaminium,N-[2-[[[dimethyl[3-[(2-methyl-1-oxo-2-propenyl)amino]propyl]ammonio]acetyl]amino]ethyl]2-hydroxy-N,N,N′,N′,N′-pentamethyl-, trichloride, a trimethylammoniopropylmethacrylamide chloride-N-Acrylamide copolymer, polydiallyldimethylammonium chloride and mixtures thereof.

14. A composition according to claim 1 wherein the composition further comprises a dispersant.

15. A composition according to claim 1 wherein the composition further comprises an inorganic salt.

16. A composition according to claim 1 wherein the composition further comprises a polymeric thickener.

17. A composition according to claim 16 wherein the polymeric thickener is selected from the group consisting of carbomers, modified carbomers, septic polyacrylates, EGDS, PEG-150 Distearate, polyethylene, PEG XM 7, PEGXM14, PEGXM23, glycerin, thixin and mixtures thereof.

18. A process of making of a composition comprising
a) from about 25 to about 70 wt % of a pyrithione or polyvalent metal salt of a pyrithione;
b) from about 0.01 to about 1 wt % of a cationic polymer with a molecular weight of about 100,000 to about 10,000,000 and a charge density of 0.1 to 7.0 meq;
c) from about 0.01 to 2 wt % of an anionic surfactant;
d) water to 100 wt %,
comprising the steps of:
1. mixing the pyrithione or polyvalent metal salt of a pyrithione, the anionic surfactant and the water using a high speed dispersing equipment or a media mill, and
2. adding a cationic polymer to a final concentration of said cationic polymer of about 0.01% to about 1% of the total composition, wherein the cationic polymer has a molecular weight range of about 100,000 to about 10,000,000 and charge density of about 0.1 to 7 meq.

19. A process of making of a composition comprising
a) from about 25 to about 70 wt % of a pyrithione or polyvalent metal salt of a pyrithione;
b) from about 0.01 to about 1 wt % of a cationic polymer with molecular weight of about 100,000 to about 10,000,000 and charge density of about 0.1 to 7.0 meq;
c) from about 0.01 to about 2 wt % of an anionic surfactant;
d) water to 100 wt %,
comprising the step of mixing the pyrithione or polyvalent metal salt of a pyrithione, the anionic surfactant, the cationic polymer and the water using a high speed dispersing equipment or a media mill.
